(19) United States
(12) Patent Application Publication
(10) Pub. No.: US 2021/0204557 A1
(43) Pub. Date: Jul. 8, 2021

(54) Milky Beverage, Method for Producing Milky Beverage, and Method for Improving Flavor of Milky Beverage

(71) Applicant: The Coca-Cola Company, Atlanta, GA (US)

(72) Inventor: Mayumi Nakamura, Tokyo (JP)

(21) Appl. No.: 15/779,200

(22) PCT Filed: Nov. 28, 2016
(86) PCT No.: PCT/IB2016/001791

§ 371 Date: May 25, 2018

(30) Foreign Application Priority Data
Nov. 26, 2015 (JP) 2015-230454

(51) Int. Cl. A23C 9/13; A23C 9/123; A23L 2/56; A23L 33/135; A23L 33/175

(52) U.S. Cl. CPC A23C 9/1322; A23C 9/1234; A23C 9/1315; A23L 33/175; A23L 2/56; A23L 33/135; A23C 9/1307

(57) ABSTRACT

Problem: To provide a flavorful milky beverage.

Solution:

A proline-containing milky beverage. This milky beverage may have the flavor of fermented milk. This milky beverage contains less than 3.0% of non-fat milk solids, and may contain less than 1,000,000 lactic acid bacteria or yeast cells per 1 mL. This milky beverage may be a yogurt flavored soft drink. This milky beverage need not contain amino acids other than proline. This milky beverage can be stored at ordinary temperatures.

### TECHNICAL FIELD

The present invention relates to a beverage, and relates to a milky beverage, a method for producing a milky beverage and a method for improving the flavor of a milky beverage.

### BACKGROUND ART

In Japan, the definitions of cows milk and dairy products are stipulated in “Ministerial Ordinance concerning the Ingredient Standards for Milk and Dairy Products” (for example, see Non-Patent Document 1). This ministerial ordinance is generally referred to as “Ministerial Ordinance on Milk etc.”. In addition, the basis for milk and dairy component standards and production methods is stipulated in Attached Table 2 “Compositional Standards and Standards of Manufacturing, Cooking, and Storing Condition of Milk, etc.” in this ordinance.

In the Ministerial Ordinance on Milk etc., “fermented milk” is defined as meaning “products which are obtained by fermenting milk, or milk etc. containing an equal or greater amount of non-fat milk solids with lactic acid bacteria or yeast and then forming a paste or liquid, or a frozen product”. With respect to compositional standards of fermented milk, attached Table 2 of this ordinance stipulates that “the non-fat milk solids content is a minimum of 8.0% and the lactic acid bacteria count or yeast count (per 1 mL) is a minimum of 1,000,000, but this does not apply to products which, after fermentation, are either heated at not lower than 75° C. for 15 minutes or pasteurized by heating having an equal or greater pasteurization effect. Coliform bacteria: negative”.

Furthermore, with respect to standards for manufacturing fermented milk, Attached Table 2 of this ordinance stipulates that “a. Raw water for fermented milk shall be potable water. b. Raw materials for fermented milk (excluding lactic acid bacteria, yeast, fermented milk and fermented milk drinks) shall either be pasteurized by heating at 63° C. for 30 minutes using a holding method or by heating by a method having an equal or greater pasteurization effect”. As is clear from these compositional standards, “fermented milk” products are dairy products in the form of soft solid yogurts or thick liquid products.

In the Ministerial Ordinance on Milk etc., “lactic acid bacteria beverages” are defined as meaning “drinks which are obtained by fermenting milk etc. with lactic acid bacteria or yeast and then processing it or using it as the principal ingredient (excluding fermented milk)”. With respect to compositional standards for lactic acid bacteria beverages (those containing a minimum of 3.0% non-fat milk solids), attached Table 2 of this ordinance stipulates that “the lactic acid bacteria count or yeast count (per 1 mL) is a minimum of 1,000,000, but this does not apply to products which, after fermentation, are either heated at not lower than 75° C. for 15 minutes or pasteurized by heating having an equal or greater pasteurization effect. Coliform bacteria: negative”.

Furthermore, with respect to standards for manufacturing lactic acid bacteria beverages (those containing a minimum of 3.0% non-fat milk solids), attached Table 2 of this ordinance stipulates that “a. Raw water used in the manufacture of a stock solution of a lactic acid bacteria beverage shall be potable water. b. Raw materials used in the manufacture of a stock solution of a lactic acid bacteria beverage (excluding lactic acid bacteria and yeast) shall either be pasteurized by heating at 63° C. for 30 minutes using a holding method or by heating by a method having an equal or greater pasteurization effect. c. Water etc. used for diluting a stock solution of a lactic acid bacteria beverage shall either be boiled for not less than 5 minutes or pasteurized by an operation having an equal or greater pasteurization effect immediately before use”.

Furthermore, with respect to compositional standards for lactic acid bacteria beverages (those containing less than 3.0% non-fat milk solids), attached Table 2 of this ordinance stipulates that “the lactic acid bacteria count or yeast count (per 1 mL) is a minimum of 1,000,000, and coliform bacteria: negative”. This ordinance stipulates that standards for manufacturing lactic acid bacteria beverages (those containing less than 3.0% non-fat milk solids) are “the same as for lactic acid bacteria beverages (those containing not less than 3.0% non-fat milk solids)”.

For example, in the case of yogurt flavored drinks, those which contain less than 3.0% of non-fat milk solids and contain less than 1,000,000 lactic acid bacteria or yeast cells per 1 mL do not correspond to “fermented milk” or “lactic acid bacteria beverages” as defined in the Ministerial Ordinance on Milk etc., and are classified as “soft drinks”. Such “soft drinks” are also known as “milky beverages”. In Japan, for example, fermented milk can only be produced using a special production line for which government approval has been granted. However, soft drinks can be produced using ordinary production lines, and do not require government approval.

Fermented milk contains amino acids, for example several milligrams of proline per 100 g. Proline is produced in milk fermentation processes. However, because the minimum concentration at which the flavor of proline can be detected is reported as being 300 mg/100 g (for example, see Non-Patent Document 2), it has been reported that amino acids hardly contribute to the taste of fermented milk (for example, see Non-Patent Document 3).

### PRIOR ART DOCUMENTS

### Non-Patent Documents

[Non-Patent Document 1] Hajime ITO, “Dairy Manufacturing Science”, Korin Publishing Co., Ltd., 28 February 2007, Reprint

[Non-Patent Document 2] Ajinomoto Co., Inc. “Amino Acids Handbook”, Kogyo Chosakai Publishing Co., Ltd., 20 February 2005, first edition, fourth printing, pages 46-47

[Non-Patent Document 3] Masato OMAE et al., “Sensory Properties and Taste Compounds of Fermented Milk Produced by Lactococcus and Streptococcus thermophilus”, Food Sci. Technol. Res., 14(2), 183-189, 2008

### SUMMARY OF INVENTION

### Problem to be Solved by the Invention

Compared to relatively concentrated fermented milk and lactic acid bacteria beverages, milky beverages have a light mouthfeel and have become widely accepted as soft drinks. However, some consumers prefer the taste of fermented milk to the taste of milky beverages. Therefore, the inventors of the present invention carried out diligent research into obtaining the taste of fermented milk in a milky beverage, and surprisingly found that by adding proline, which had been thought in the past to hardly contribute to the taste of fermented milk, to a milky beverage, the milky beverage had the taste of fermented milk and became flavorful. As a result, an objective of the present invention is to provide a flavorful milky beverage, a method for producing a milky beverage and a method for improving the flavor of a milky beverage.

### Means for Solving the Problem

Provided by a mode of the present invention is a proline-containing milky beverage. This milky beverage may have the flavor of fermented milk. This milky beverage contains less than 3.0% of non-fat milk solids, and may contain less than 1,000,000 lactic acid bacteria or yeast cells per 1 mL. This milky beverage may be a yogurt flavored soft drink. Alternatively, this milky beverage may be a soft drink having a combined flavor of yogurt and fruit. This milky beverage need not contain amino acids other than proline. This milky beverage can be stored at ordinary temperatures.

This milky beverage may contain 0.0010-0.0600 g of proline per 100 g of the milky beverage.

This milky beverage may contain 0.0060-0.0300 g of proline per 100 g of the milky beverage. In such cases, the milky beverage may be a non-carbonated beverage.

This milky beverage may contain 0.0060-0.0120 g of proline per 100 g of the milky beverage. In such cases, the milky beverage may be a carbonated beverage.

Provided by another mode of the present invention is a method for producing a milky beverage, the method including (a) a step of preparing a milky beverage material and (b) a step of adding proline to the milky beverage material. Here, milky beverage material means a milky beverage that does not contain proline. Proline may be added to the milky beverage material so that a produced milky beverage has a fermented milk flavor.

In this method for producing a milky beverage, a produced milky beverage contains less than 3.0% of non-fat milk solids and may contain less than 1,000,000 lactic acid bacteria or yeast cells per 1 mL. In addition, a produced milky beverage may be a yogurt flavored soft drink. Alternatively, a produced milky beverage may be a soft drink having a combined flavor of yogurt and fruit. A produced milky beverage need not contain amino acids other than proline. A produced milky beverage can be stored at ordinary temperatures.

In this method for producing a milky beverage, proline may be added to the milky beverage material so that a produced milky beverage contains 0.0010-0.0600 g of proline per 100 g of the milky beverage.

In this method for producing a milky beverage, proline may be added to the milky beverage material so that a produced milky beverage contains 0.0060-0.0300 g of proline per 100 g of the milky beverage. In such cases, a produced milky beverage may be a non-carbonated beverage.

In this method for producing a milky beverage, proline may be added to the milky beverage material so that a produced milky beverage contains 0.0060-0.0120 g of proline per 100 g of the milky beverage. In such cases, a produced milky beverage may be a carbonated beverage.

Provided by a further mode of the present invention is a method for improving the flavor of a milky beverage, the method including (a) a step of preparing a milky beverage and (b) a step of adding proline to the milky beverage. Proline may be added to the milky beverage so that the milky beverage has a fermented milk flavor.

In this method for improving the flavor of a milky beverage, the milky beverage contains less than 3.0% of non-fat milk solids and may contain less than 1,000,000 lactic acid bacteria or yeast cells per 1 mL. In addition, the milky beverage may be a yogurt flavored soft drink. Alternatively, the milky beverage may be a soft drink having a combined flavor of yogurt and fruit. The milky beverage need not contain amino acids other than proline. The milky beverage can be stored at ordinary temperatures.

In this method for improving the flavor of a milky beverage, proline may be added to the milky beverage so that the milky beverage contains 0.0010-0.0600 g of proline per 100 g of the milky beverage.

In this method for improving the flavor of a milky beverage, proline may be added to the milky beverage so that the milky beverage contains 0.0060-0.0300 g of proline per 100 g of the milky beverage. In such cases, the milky beverage may be a non-carbonated beverage.

In this method for improving the flavor of a milky beverage, proline may be added to the milky beverage so that the milky beverage contains 0.0060-0.0120 g of proline per 100 g of the milky beverage. In such cases, the milky beverage may be a carbonated beverage.

Provided by a further mode of the present invention is a method for suppressing sourness in a milky beverage, the method including (a) a step of preparing a milky beverage and (b) a step of adding proline to the milky beverage.

In this method for suppressing sourness in a milky beverage, the milky beverage contains less than 3.0% of non-fat milk solids and may contain less than 1,000,000 lactic acid bacteria or yeast cells per 1 mL. In addition, the milky beverage may be a yogurt flavored soft drink. Alternatively, the milky beverage may be a soft drink having a combined flavor of yogurt and fruit. The milky beverage need not contain amino acids other than proline. The milky beverage can be stored at ordinary temperatures.

In this method for suppressing sourness in a milky beverage, proline may be added to the milky beverage so that the milky beverage contains 0.0005-0.0600 g of proline per 100 g of the milky beverage.

In this method for suppressing sourness in a milky beverage, proline may be added to the milky beverage so that the milky beverage contains 0.0060-0.0600 g of proline per 100 g of the milky beverage. In such cases, the milky beverage may be a non-carbonated beverage.

In this method for suppressing sourness in a milky beverage, proline may be added to the milky beverage so that the milky beverage contains 0.0020-0.0120 g of proline per 100 g of the milky beverage. In such cases, the milky beverage may be a carbonated beverage.

### Advantageous Effects of Invention

According to the present invention, it is possible to provide a flavorful milky beverage, a method for producing a milky beverage and a method for improving the flavor of a milky beverage.

### BRIEF DESCRIPTION OF DRAWINGS

FIG. 1 is a table showing results of Working Example 1.

FIG. 2 is a table showing the composition of a non-carbonated milky beverage according to Working Example 2.

FIG. 3 is a table showing results of Working Example 2.

FIG. 4 is a table showing results of Working Example 3.

FIG. 5 is a table showing the composition of a carbonated milky beverage according to Working Example 4.

FIG. 6 is a table showing results of Working Example 4.

FIG. 7 is a table showing results of Working Example 5.

### MODE FOR CARRYING OUT THE INVENTION

Embodiments of the present invention will now be explained. However, it should not be understood that statements and drawings that form parts of these disclosures limit the invention. A variety of alternative embodiments, examples and operational techniques should be clear to a person skilled in the art from these disclosures. Therefore, it should be understood that the present invention encompasses a variety of embodiments etc. that are not disclosed here.

A milky beverage according to an embodiment of the present invention is a proline-containing milky beverage. The milky beverage according to this embodiment may have a fermented milk flavor. The milky beverage according to this embodiment contains less than 3.0% of non-fat milk solids, and may contain fewer than 1,000,000 lactic acid bacteria or yeast cells per 1 mL. In addition, the milky beverage according to this embodiment may be a yogurt flavored soft drink. Alternatively, the milky beverage according to this embodiment may be a soft drink having a combined flavor of yogurt and fruit. A fruit flavor may be obtained by adding pulp, skin, juice, or the like, of a fruit, and may also be obtained by adding a flavor (food additive) that imparts a fruit flavor. The fruit may be tangerine, orange, grapefruit, grape, blueberry, plum, peach, melon, apple, pineapple, strawberry, cherry, kiwi, or the like, but is not limited to these. In addition, the milky beverage according to this embodiment may be a soft drink having a flavor obtained by combining yogurt with powdered green tea, brown sugar syrup, maple syrup, or the like. Furthermore, the milky beverage according to this embodiment need not contain amino acids other than proline.

The milky beverage according to this embodiment may contain 0.0010-0.0600 g of proline per 100 g of the milky beverage. By setting the content of proline to fall within this range, the milky beverage tends to have a fermented milk flavor. Alternatively, the milky beverage according to this embodiment may contain 0.0060-0.0300 g of proline per 100 g of the milky beverage. In such cases, the milky beverage according to this embodiment may be a non-carbonated beverage. Alternatively, the milky beverage according to this embodiment may contain 0.0060-0.0120 g of proline per 100 g of the milky beverage. In such cases, the milky beverage according to this embodiment may be a carbonated beverage.

“Fermented milk” means a product which contains, for example, a minimum of 8.0% of non-fat milk solids, is obtained through fermentation with lactic acid bacteria or yeast, and contains a minimum of 107 lactic acid bacteria or yeast cells per 1 mL.

A “lactic acid bacteria beverage” is, for example, a beverage containing less than 8.0% of non-fat milk solids. Among “lactic acid bacteria beverages”, those containing a minimum of 3.0% of non-fat milk solids and containing a minimum of 107 lactic acid bacteria or yeast cells per 1 mL are also known as “dairy product lactic acid bacteria beverages”. Among “lactic acid bacteria beverages”, those which contain a minimum of 3.0% of non-fat milk solids and in which lactic acid bacteria or yeast cells are killed by sterilization are also known as “(sterilized) dairy product lactic acid bacteria beverages”. Among “lactic acid bacteria beverages”, those which contain less than 3.0% of non-fat milk solids and contain a minimum of 106 lactic acid bacteria or yeast cells per 1 mL are also known as “lactic acid bacteria beverages containing mainly milk etc.”.

“Milky beverages” are, for example, beverages which contain less than 3.0% of non-fat milk solids and contain fewer than 1,000,000 lactic acid bacteria or yeast cells per 1 mL, do not correspond to “fermented milk” or “lactic acid bacteria beverages”, and are classified as “soft drinks”. “Milky beverages” have a low milk content, and can therefore be stored at ordinary temperatures. Ordinary temperatures means, for example, 0-40° C., 0-35° C. or 0-30° C.

The milky beverage according to this embodiment can be produced by, for example, preparing a milky beverage material, which is a milky beverage that does not contain proline, and adding proline to the milky beverage material. In Japan, for example, fermented milk can only be produced using a special production line for which government approval has been granted. However, proline-containing milky beverages are soft drinks, and can therefore be produced using ordinary production lines and do not require government approval.

The milky beverage that does not contain proline may be a commercially available milky beverage. By preparing a commercially available milky beverage and adding proline to this commercially available milky beverage, the flavor of the milky beverage is improved and the milky beverage has a fermented milk flavor.

It is possible to add proline to the milky beverage in order to suppress sourness in the milky beverage. In such cases, by adding proline to the milky beverage so that the milky beverage contains 0.0005-0.0600 g of proline per 100 g of the milky beverage, sourness tends to be suppressed. Alternatively, in order to suppress sourness in the milky beverage, proline may be added to the milky beverage so that the milky beverage contains 0.0060-0.0600 g of proline per 100 g of the milky beverage. In such cases, the milky beverage may be a non-carbonated beverage. Alternatively, in order to suppress sourness in the milky beverage, proline may be added to the milky beverage so that the milky beverage contains 0.0020-0.0120 g of proline per 100 g of the milky beverage. In such cases, the milky beverage may be a carbonated beverage.

### WORKING EXAMPLE 1

Samples of the following fermented milk beverages and lactic acid bacteria beverages were procured. All of these were beverages having different brand names.

Commercially available fermented milk beverage 1 (yogurt drink, able to be transported if refrigerated)

Commercially available fermented milk beverage 2 (yogurt drink, able to be transported if refrigerated)

Commercially available fermented milk beverage 3 (yogurt drink, able to be transported if refrigerated)

Commercially available fermented milk beverage 4 (yogurt drink, able to be transported if refrigerated)

Commercially available lactic acid bacteria beverage 1 (able to be transported if refrigerated)

Commercially available lactic acid bacteria beverage 2 (able to be transported if refrigerated)

Commercially available lactic acid bacteria beverage 3 (able to be transported if refrigerated)

In addition, samples of the following milky beverages were procured or prepared. All of these were beverages having different brand names.

Commercially available milky beverage 1 (soft drink, able to be transported at ordinary temperatures)

Commercially available milky beverage 2 (soft drink, able to be transported at ordinary temperatures)

Commercially available milky beverage 3 (soft drink, able to be transported at ordinary temperatures)

Commercially available milky beverage 4 (soft drink, able to be transported at ordinary temperatures)

Prototype prepared by the inventor of the present invention (soft drink, non-fat milk solids: 1.2%, milk fat: 0.2%, able to be transported at ordinary temperatures)

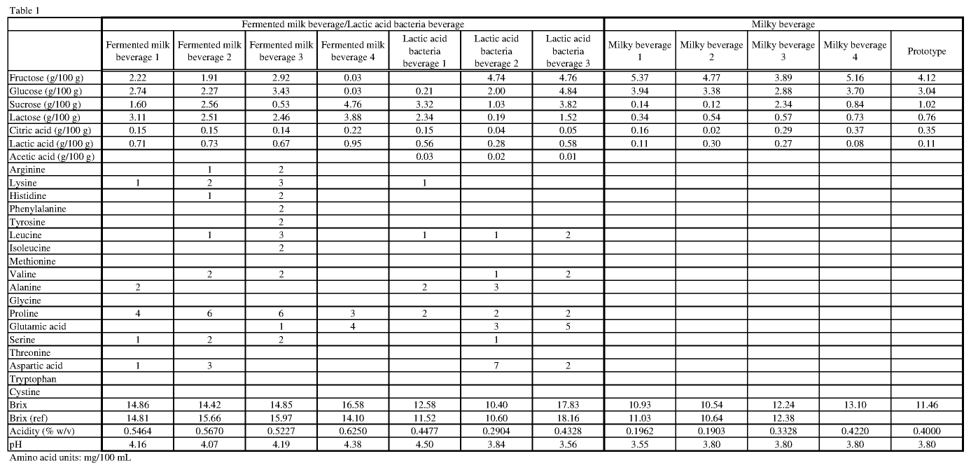

The compositions of the procured or prepared samples were analyzed. Analysis of sugars and acids was carried out by high performance liquid chromatography (using a LC-20AD manufactured by Shimadzu Corporation). Analysis of amino acids was carried out using a high-speed amino acid analyzer (L-8800 manufactured by Hitachi High-Technologies Corporation). Brix analysis was carried out in an oscillation period method using a DA-310C manufactured by Kyoto Electronics Manufacturing Co., Ltd. Brix (Ref) analysis was carried out by refractive index measurements using a RX-5000a manufactured by Atago Co., Ltd. Acidity analysis was carried out using an AT-510 manufactured by Kyoto Electronics Manufacturing Co., Ltd. pH analysis was carried out using a HM-30G manufactured by DKK-TOA Corporation. The results are shown in FIG. 1.

In all of these fermented milk beverages and lactic acid bacteria beverages, the content of lactic acid was greater than the content of citric acid. In the milky beverages, however, the content of lactic acid was lower than the content of citric acid, except in commercially available milky beverage 2.

Amino acids were detected in the fermented milk beverages and lactic acid bacteria beverages. Lysine, leucine, valine, alanine, proline, serine and aspartic acid were detected in 3 or more fermented milk beverages or lactic acid bacteria beverages. However, amino acids were not detected in the milky beverages.

The pH values of the fermented milk beverages and lactic acid bacteria beverages were higher than the pH values of the milky beverages.

### WORKING EXAMPLE 2

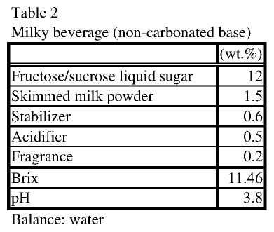

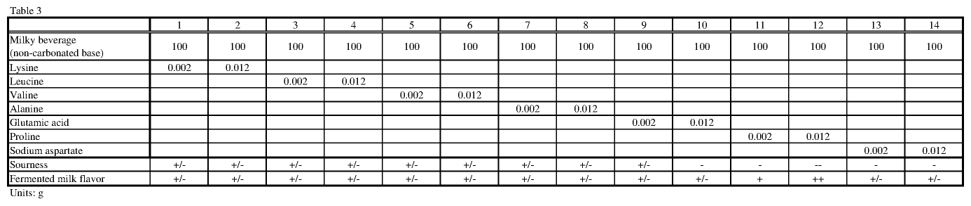

A non-carbonated milky beverage which had the composition shown in FIG. 2 and contained no amino acids was prepared. This non-carbonated milky beverage was the same as the prototype shown in FIG. 1. Citric acid and lactic acid were used as acidifiers. Carboxymethyl cellulose (CMC), pectin and xanthan gum were used as stabilizers. Amino acids were added to the non-carbonated milky beverage so that 0.002 g or 0.012 g of the amino acids shown in FIG. 3 were contained per 100 g of the prepared non-carbonated milky beverages. The sourness and fermented milk flavor of the amino acid-containing non-carbonated milky beverages were functionally evaluated by 5 panelists experienced in beverage evaluation.

In FIG. 3, “+/−” for sourness indicates that the sourness was not altered by the addition of the amino acid. “−” for sourness indicates that sourness was suppressed by the addition of the amino acid. “−−” for sourness indicates that sourness was more suppressed by the addition of the amino acid.

In FIG. 3, “+/−” for fermented milk flavor indicates that the flavor was not altered by the addition of the amino acid. “+” for fermented milk flavor indicates that the fermented milk flavor was enhanced by the addition of the amino acid. “++” for fermented milk flavor indicates that the fermented milk flavor was more enhanced by the addition of the amino acid.

As shown in FIG. 3, even when amino acids other than proline (lysine, leucine, valine, alanine, glutamic acid and sodium aspartate) were added to a milky beverage, the fermented milk flavor was not enhanced, but by adding proline to a milky beverage, sourness was suppressed and the fermented milk flavor was enhanced.

### WORKING EXAMPLE 3

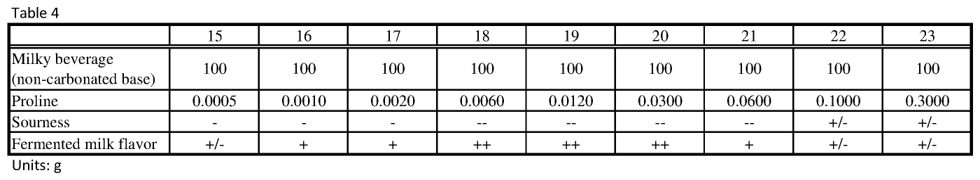

Proline was added to the same non-carbonated milky beverage as that used in Working Example 2 so that the content of proline was 0.0005 g, 0.0010 g, 0.0020 g, 0.0060 g, 0.0120 g, 0.0300 g, 0.0600 g, 0.1000 g or 0.3000 g per 100 g of the milky beverage, as shown in FIG. 4. The sourness and fermented milk flavor of these proline-containing non-carbonated milky beverages were functionally evaluated by the same 5 panelists as in Working Example 2. The evaluation criteria were the same as in Working Example 2.

The results showed that in cases where the content of proline was 0.0010 g or 0.0020 g per 100 g of the non-carbonated milky beverage, the sourness was evaluated as “−” and the fermented milk flavor was evaluated as “+”. In cases where the content of proline was 0.0060 g, 0.0120 g or 0.0300 g per 100 g of the non-carbonated milky beverage, the sourness was evaluated as “−−” and the fermented milk flavor was evaluated as “++”. In cases where the content of proline was 0.0600 g per 100 g of the non-carbonated milky beverage, the sourness was evaluated as “−−” and the fermented milk flavor was evaluated as “+”.

### WORKING EXAMPLE 4

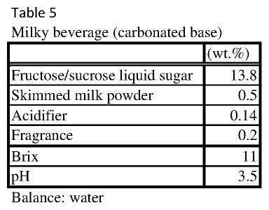

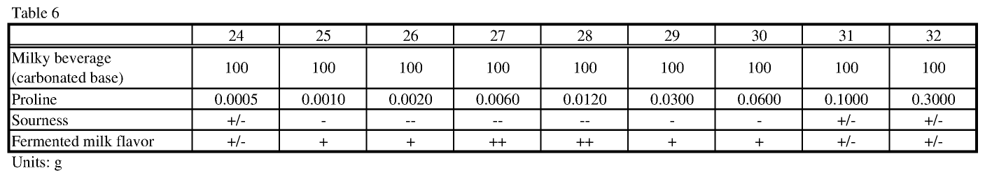

A carbonated milky drink which had the composition shown in FIG. 5 and which did not contain amino acids was prepared. Proline was added to the prepared carbonated milky beverage so that the content of proline was 0.0005 g, 0.0010 g, 0.0020 g, 0.0060 g, 0.0120 g, 0.0300 g, 0.0600 g, 0.1000 g or 0.3000 g per 100 g of the milky beverage, as shown in FIG. 6. The sourness and fermented milk flavor of these proline-containing carbonated milky beverages were functionally evaluated by the same 5 panelists as in Working Example 2. The evaluation criteria were the same as in Working Example 2.

In cases where the content of proline was 0.0010 g per 100 g of the carbonated milky beverage, the sourness was evaluated as “−” and the fermented milk flavor was evaluated as “+”. In cases where the content of proline was 0.0020 g per 100 g of the carbonated milky beverage, the sourness was evaluated as “−−” and the fermented milk flavor was evaluated as “+”. In cases where the content of proline was 0.0060 g or 0.0120 g per 100 g of the carbonated milky beverage, the sourness was evaluated as “−−” and the fermented milk flavor was evaluated as “++”. In cases where the content of proline was 0.0300 g or 0.0600 g per 100 g of the carbonated milky beverage, the sourness was evaluated as “−” and the fermented milk flavor was evaluated as “+”.

### WORKING EXAMPLE 5

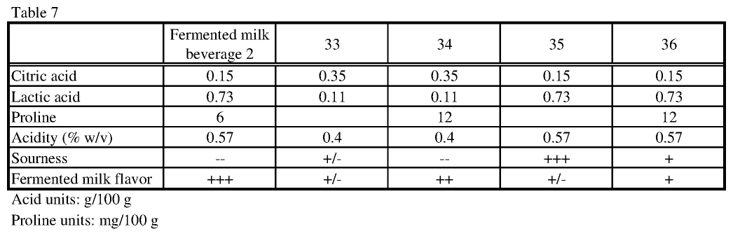

Commercially available fermented milk beverage 2 was prepared in the same way as in Working Example 1. In addition, a non-carbonated milky beverage was prepared in the same way as in Working Example 2. Furthermore, samples 33 to 36 were obtained by adjusting the content of citric acid and lactic acid in non-carbonated milky beverages as shown in FIG. 7. The sourness and fermented milk flavor of commercially available fermented milk beverage 2 and samples 33 to 36 were functionally evaluated by the same 5 panelists as in Working Example 2. The evaluation criteria were the same as in Working Example 2, “+” for sourness indicates that the sourness was increased by the addition of citric acid and lactic acid, and “++” for sourness indicates that the sourness was further increased by the addition of citric acid and lactic acid. In addition, “+++” for fermented milk flavor indicates that the fermented milk flavor was further enhanced.

The content of lactic acid was greater than the content of citric acid in commercially available fermented milk beverage 2. However, milky beverage sample 35, in which the content of lactic acid was greater than the content of citric acid, showed increased sourness compared to milky beverage sample 33, in which the content of citric acid was greater than the content of lactic acid. Furthermore, despite the content of citric acid and the content of lactic acid being the same as in commercially available fermented milk beverage 2, milky beverage sample 35 exhibited higher sourness and did not have a fermented milk flavor.

Sourness was suppressed and the fermented milk flavor was enhanced in milky beverage sample 34, which was obtained by adding proline to milky beverage sample 33. In addition, sourness was suppressed and the fermented milk flavor was enhanced in milky beverage sample 36, which was obtained by adding proline to milky beverage sample 35.

1. A milky beverage comprising proline.

2. The milky beverage of claim 1, wherein the milky beverage comprises less than 3.0% of non-fat milk solids and contains less than 1,000,000 lactic acid bacteria or yeast cells per 1 mL.

3. The milky beverage of claim 1, wherein the milky beverage is a yogurt flavored soft drink.

4. (canceled)

5. The milky beverage of claim 1, wherein the milky beverage does not contain amino acids other than proline.

6. The milky beverage of claim 1, wherein the milky beverage can be stored at a temperature from 0-40° C.

7. The milky beverage of claim 1, wherein the milky beverage contains 0.0010-0.0600 g of proline per 100 g of the milky beverage.

8.-11. (canceled)

12. The milky beverage of claim 1, wherein the milky beverage has a fermented milk flavor.

13. A method for producing a milky beverage, the method comprising:
preparing a milky beverage material, and
adding proline to the milky beverage material to provide a milky beverage.

14. The method of claim 13, wherein the milky beverage contains less than 3.0% of non-fat milk solids and contains less than 1,000,000 lactic acid bacteria or yeast cells per 1 mL.

15. The method of claim 13, wherein the milky beverage is a yogurt flavored soft drink.

16. (canceled)

17. The method of claim 13, wherein the milky beverage does not contain amino acids other than proline.

18. The method of claim 13, wherein the milky beverage can be stored at a temperature from 0-40° C.

19. The method of claim 13, wherein proline is added to the milky beverage material so that the milky beverage contains 0.0010-0.0600 g of proline per 100 g of the milky beverage.

20.-24. (canceled)

25. A method for improving the flavor of a milky beverage, the method comprising:
preparing a milky beverage, and
adding proline to the milky beverage to provide a milky beverage with improved flavor.

26. The method f of claim 25, wherein the milky beverage with improved flavor contains less than 3.0% of non-fat milk solids and contains less than 1,000,000 lactic acid bacteria or yeast cells per 1 mL.

27. The method of claim 25, wherein the milky beverage with improved flavor is a yogurt flavored soft drink.

28. (canceled)

29. The method for of claim 25, wherein the milky beverage with improved flavor does not contain amino acids other than proline.

30. (canceled)

31. The method of claim 25, wherein proline is added to the milky beverage so that the milky beverage comprising proline contains 0.0010-0.0600 g of proline per 100 g of the milky beverage.

32.-36. (canceled)

37. A method for suppressing sourness in a milky beverage, the method comprising:
preparing a milky beverage, and
adding proline to the milky beverage to provide a milky with suppressed sourness.

38. The method of claim 37, wherein the milky beverage with suppressed sourness contains less than 3.0% of non-fat milk solids and contains less than 1,000,000 lactic acid bacteria or yeast cells per 1 mL.

39. The method of claim 37, wherein the milky beverage with suppressed sourness is a yogurt flavored soft drink.

40. (canceled)

41. The method of claim 37, wherein the milky beverage with suppressed sourness does not contain amino acids other than proline.

42. (canceled)

43. The method of claim 37, wherein proline is added to the milky beverage so that the milky beverage with suppressed sourness contains 0.0005-0.0600 g of proline per 100 g of the milky beverage.

44.-47. (canceled)
